(19) United States
(12) Patent Application Publication
(10) Pub. No.: US 2022/0415015 A1
(43) Pub. Date: Dec. 29, 2022

(54) SERVICE PROVIDING APPARATUS AND METHOD FOR SKIN CARE BASED ON IMAGE ANALYSIS

(71) Applicant: F.S.KOREA INDUSTRIES INC., Seoul (KR)

(72) Inventor: Jae Kwang HWANG, Seoul (KR)

(21) Appl. No.: 17/752,691

(22) Filed: May 24, 2022

(30) Foreign Application Priority Data
Jun. 23, 2021 (KR) 10-2021-0081325

(51) Int. Cl. G06V 10/70; G06V 20/60; G06V 40/10; G06T 7/00; G06Q 30/06

(52) U.S. Cl. CPC G06V 10/70; G06V 20/60; G06V 40/10; G06T 7/0012; G06Q 30/0631; G06T 2207/30088; G06T 2207/20081

(57) ABSTRACT

Disclosed are service providing apparatus and method for skin care based on image analysis by identifying a using cosmetic used by a user by analyzing an image obtained by photographing a cosmetic container with a camera based on deep learning, predicting the user's skin type by analyzing the using cosmetic based on deep learning, and then recommending a cosmetic suitable for the user's skin type. According to the present disclosure, it is possible to enhance user's convenience and satisfaction with skin care and reduce the time and cost required for selecting cosmetics suitable for the user's skin type by analyzing the cosmetics held by the user through artificial intelligence based on deep learning to estimate the user's skin type and then automatically selecting and providing cosmetics suitable for the user's skin type from among the cosmetics held by the user according to the estimated skin type.

### CROSS-REFERENCE TO RELATED APPLICATIONS

This application claims the priority of Korean Patent Application No. 10-2021-0081325 filed on Jun. 23, 2021, in the Korean Intellectual Property Office, the disclosure of which is incorporated herein by reference.

### BACKGROUND OF THE INVENTION

### Field of the Invention

The present disclosure relates to service providing apparatus and method for skin care based on image analysis, and more particularly, to service providing apparatus and method for skin care based on image analysis by analyzing an image obtained by photographing a cosmetic container with a camera based on deep learning to identify using cosmetics, analyzing the using cosmetics based on deep learning to predict a user's skin type, and then recommending cosmetics suitable for the user's skin type.

### Description of the Related Art

Recently, interest in skin care to protect the skin from the atmospheric environment containing pollutants and maintain a healthy skin has been increased, and the types of skin troubles have been also diversified due to a continuous change in the external environment. Accordingly, the development of cosmetics to prevent these skin troubles in advance has also continued.

However, it is difficult for a user to analyze his or her skin type, and thus, it is very difficult to select cosmetics suitable for his or her skin type from among various cosmetics.

Accordingly, the user selects and uses cosmetics that are not suitable for his or her skin type to rather aggravate the skin troubles, and in the process of selecting the cosmetics suitable for his or her skin, the user needs to purchase cosmetics that are not suitable for his or her skin type, and thus, there is a significant cost burden on the user.

The above-described technical configuration is the background art for helping in the understanding of the present disclosure, and does not mean a conventional technology widely known in the art to which the present disclosure pertains.

### SUMMARY OF THE INVENTION

An object of the present disclosure is to minimize the user's time and cost required for selecting cosmetics for improving a skin condition by receiving an image of a cosmetic container used by a user from the user, applying the corresponding image to a model learned for identifying the cosmetics to identify the cosmetics used by the user, analyzing the using cosmetics based deep learning to predict a user's skin type, and then recommending cosmetics suitable for the user's skin type.

According to an aspect of the present disclosure, a service providing apparatus for skin care based on image analysis may include a communication unit that receives from a user terminal request information including a cosmetic-specific container image obtained by photographing the container for each of one or more using cosmetics; a container analysis unit that learns a correlation between the container image of the cosmetic and the cosmetic identification information corresponding to the cosmetic to acquire one or more pieces of cosmetic identification information corresponding to the request information by applying the cosmetic-specific container image included in the request information to a preset first learning model; a skin type analysis unit that includes a second learning model in which a correlation between ingredients constituting the cosmetics and the skin type is learned; and a control unit that acquires one or more pieces of cosmetic identification information corresponding to the request information by the container analysis unit when receiving the request information by the communication unit, searches for the storage unit based on the acquired one or more pieces of cosmetic identification information to acquire one or more pieces of cosmetic information corresponding to the acquired one or more pieces of cosmetic identification information as holding cosmetic information of each user, extracts ingredient information from each of the one or more pieces of holding cosmetic information and then applies the extracted one ore more pieces of ingredient information to the second learning model in conjunction with the skin type analysis unit to determine an estimated skin type predicted for the user, and provides determination result information of determining whether one or more pieces of holding cosmetic information are suitable for the estimated skin type and include information on avoidable ingredients that need to be avoided, based on the reference information corresponding to the estimated skin type.

The control unit may set cosmetic information which is suitable for a user and does not contain ingredients to be avoided among the one or more pieces of holding cosmetic information as cosmetics to be used based on the determination result information, and generates schedule information related to a usage schedule for the one or more pieces of cosmetic information to be used based on at least one of the amount and usage included in each of the information on one or more cosmetics to be used and a using method in combination with cosmetics belonging to different categories to transmit the generated schedule information to the user terminal.

The storage unit stores information on one or more cosmetic tools matching at least one of a plurality of pieces of cosmetic information, and the control unit may search for the storage unit based on the cosmetic information to be used and matches specific cosmetic tool information with cosmetic information matched with the specific cosmetic tool information in the schedule information to be included in the schedule information, when there is the specific cosmetic tool information matched with the cosmetic information to be used.

The request information may include skin condition information including whether skin troubles occur while including a first image that photographs the skin condition of a specific body part where skin troubles have occurred or a second image that photographs the skin condition of a specific body part where skin troubles does not occurred, and body part information on a container image for each cosmetic obtained by photographing the container for each of one or more cosmetics used on the specific body part, and a name for the specific body part. The service providing apparatus may further include a learning unit that matches one or more pieces of cosmetic identification information obtained by the container analysis unit with the second image and the body part information only for request information including the second image for the skin without the skin troubles to learn the matched information in a preset third learning model, wherein the control unit applies any one of the first image and the second image and the body part information included in the request information to the third learning model as input information in conjugation with the learning unit when receiving the request information to calculate output information including cosmetic identification information for each of one or more cosmetics estimated to be used for a skin type similar to the user's skin type through the third learning model, and searches for the storage unit based on one or more pieces of cosmetic identification information included in the output information to generate cosmetic recommendation information including one or more pieces of cosmetic information corresponding to the output information and then transmits the generated cosmetic recommendation information to the user terminal.

The control unit may receive cosmetic combination information for each of one or more new cosmetics corresponding to the second image extracted from the request information including the second image through the communication unit and matches the second image and the cosmetic combination information with the body part information extracted from the request information corresponding to the second image to learn the matched information in the third learning model.

When the control unit may receive the feedback information including cosmetic identification information for one or more using cosmetics used by the user among the recommendation cosmetics included in the cosmetic recommendation information from the user terminal that has received the cosmetic recommendation information, the control unit may extract the first image or the second image and the body part information from the request information corresponding to the feedback information and then match the extracted image and body part information with cosmetic identification information for each of one or more using cosmetics included in the feedback information to learn learning data, and learn the learning data corresponding to the feedback information in the third learning model in conjugated with the learning unit.

At this time, the control unit may confirm a recommendation score according to the feedback information to generate the learning data based on the feedback information only when the recommendation score is equal to or greater than a preset reference value, and learn the generated learning data in the third learning model.

The control unit may match one or more pieces of holding cosmetic information corresponding to the request information with member information of the user corresponding to the user terminal to cumulatively store the matched information in the storage unit, generate preference information for the user based on the cumulatively stored holding cosmetic information, and reflect the preference information when generating the cosmetic recommendation information to select one or more recommendation cosmetics to be included in the cosmetic recommendation information.

The preference information may include at least one of a brand, a price range, and ingredients preferred by the user for each cosmetic category.

The container image may include image data on at least one of a label of the cosmetic container, a shape of the cosmetic container, a size of the cosmetic container, a color of the cosmetic container, a bar code of the cosmetic container, and the like.

According to another aspect of the present disclosure, a service providing method for skin care based on image analysis may include steps of: receiving, by a service providing apparatus, from a user terminal request information including a cosmetic-specific container image obtained by photographing a container for each of one or more using cosmetics; learning, by the service providing apparatus, a correlation between the container image of the cosmetic and cosmetic identification information corresponding to the cosmetic to acquire one or more pieces of cosmetic identification information corresponding to the request information by applying the cosmetic-specific container image included in the request information to a preset first learning model; searching, by the service providing apparatus, for the storage unit of the service providing apparatus in which the cosmetic information on each of a plurality of different cosmetics and reference information for the cosmetic selection reference for each of the plurality of different skin types are stored based on the one or more pieces of cosmetic identification information to acquire one or more pieces of cosmetic information corresponding to the one or more pieces of cosmetic identification information as the holding cosmetic information of the user, respectively; extracting, by the service providing apparatus, ingredient information from each of the one or more pieces of holding cosmetic information and then applying the extracted one or more pieces of ingredient information to a preset second learning model in which a correlation between the ingredients constituting the cosmetic and the skin type is learned to determine an estimated skin type predicted for the user; and generating, by the service providing apparatus, determination result information of determining whether the one or more pieces of holding cosmetic information are suitable for the estimated skin type and include information on ingredients to be avoided based on the reference information corresponding to the estimated skin type to provide the generated determination result information to the user terminal.

According to the present disclosure, it is possible to increase the convenience for the holding cosmetic input of the user by identifying the cosmetics held by the user only by photographing the containers of the cosmetics held by the user. In addition, it is possible to enhance user's convenience and satisfaction with skin care and reduce the time and cost required for selecting cosmetics suitable for the user's skin type by analyzing the cosmetics held by the user through artificial intelligence based on deep learning to estimate the user's skin type and then automatically selecting and providing cosmetics suitable for the user's skin type from among the cosmetics held by the user according to the estimated skin type.

Further, according to the present disclosure, it is possible to support the skin troubles of an abnormal user by dividing users requesting a recommendation cosmetic for skin care into an abnormal user with skin troubles and a normal user without skin troubles to first learn a learning model with the image for the skin condition and holding cosmetics of the normal user and then recommending cosmetics to be preferred between normal users with a skin type similar to that of the abnormal user through the corresponding leaning model to induce the abnormal user to use the preference cosmetics of the normal users similar to the skin type of the abnormal user. Further, according to the present disclosure, it is possible to increase accuracy and reliability for the cosmetic recommendation capable of improving the skin troubles by receiving the feedback information form the abnormal user when the cosmetics to be recommended in the future has an effect of improving the skin troubles to learn the recommendation cosmetics used for improving skin troubles according to the image with the skin troubles first transmitted by the abnormal user and the feedback information in the learning model, so that the skin troubles occur, and more accurately selecting experienced persons who have experienced skin troubles similar to those of new users based on the learning model for new users who request cosmetic recommendation to recommend the cosmetics recommended by the corresponding experienced persons to new users.

Further, according to the present disclosure, the most preferred cosmetics are recommended between other normal users having the skin type similar to the abnormal user through the learning model with respect to the cosmetic recommendation request of the normal user without skin troubles to support the user without skin troubles to recommend the cosmetics in which opinions of the plurality of users are reflected to improve the skin of the user, thereby providing a cosmetic recommendation function capable of satisfying both the user with skin troubles and the user without skin troubles.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic environment diagram of a service providing apparatus for skin care based on image analysis according to an embodiment of the present disclosure;

FIG. 2 is a schematic diagram of a service providing apparatus for skin care based on image analysis according to an embodiment of the present disclosure;

FIG. 3 is an exemplary diagram of an operation of a service providing apparatus for skin care based on image analysis according to an embodiment of the present disclosure;

FIG. 4 is an exemplary diagram of an operation of a service providing apparatus for skin care based on image analysis according to another embodiment of the present disclosure; and

FIG. 5 is a flowchart of a service providing method for skin care based on image analysis according to an embodiment of the present disclosure.

### DETAILED DESCRIPTION OF THE PREFERRED EMBODIMENT

Hereinafter, embodiments of the present disclosure will be described in detail with reference to the drawings.

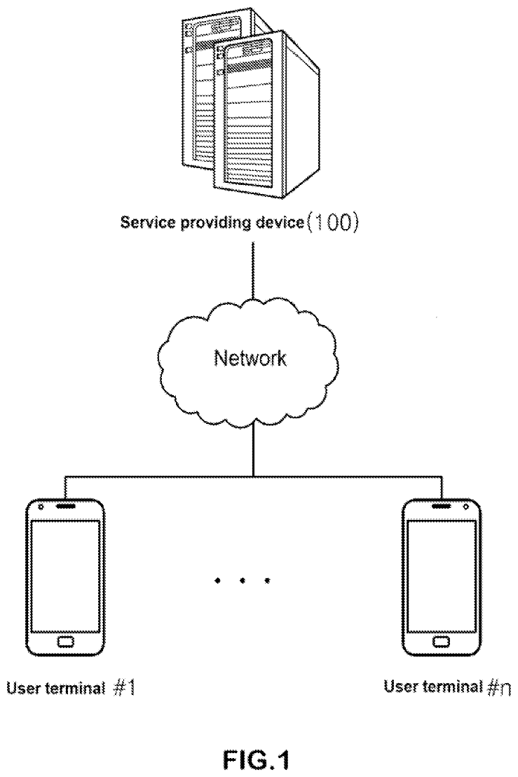

FIG. 1 is a schematic environment diagram of a service providing apparatus 100 (hereinafter, a service providing apparatus) for skin care based on image analysis according to an embodiment of the present disclosure.

As illustrated in FIG. 1, the service providing apparatus 100 may communicate with a plurality of user terminals via a communication network.

In addition, the communication network described in the present disclosure may include a wired/wireless communication network. Examples of such a wireless communication network may include Wireless LAN (WLAN), Digital Living Network Alliance (DLNA), Wireless Broadband (WiBro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term. Evolution (LTE), Long Term Evolution-Advanced (LTE-A), Wireless Mobile Broadband Service (WMBS), 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc. Further, examples of the wired communication network may include a wired local area network (LAN), wired wide area network (WAN), power line communication (PLC), USB communication, Ethernet, serial communication, optical/coaxial cables, etc.

In addition, the user terminal may include various terminals with a communication function, such as a smart phone, a portable terminal, a mobile terminal, a personal digital assistant (PDA), and the like.

In addition, the service providing apparatus 100 may be configured as a service server.

According to the above-described configuration, the service providing apparatus 100 includes a cosmetic container image for each of one or more cosmetics generated by photographing a cosmetic container for each of one or more cosmetics held by a user from the user terminal, and may receive request information for asking for analyzing or recommending cosmetics for skin care. In addition, the service providing apparatus 100 may analyze a user's skin type corresponding to the request information through preset deep learning-based artificial intelligence analysis, provide information to exclude products that are not suitable for the user from among the cosmetics held by the user based on the corresponding skin type, and provide information about a use schedule for the cosmetics held for improving the user's skin. It will be described in detail.

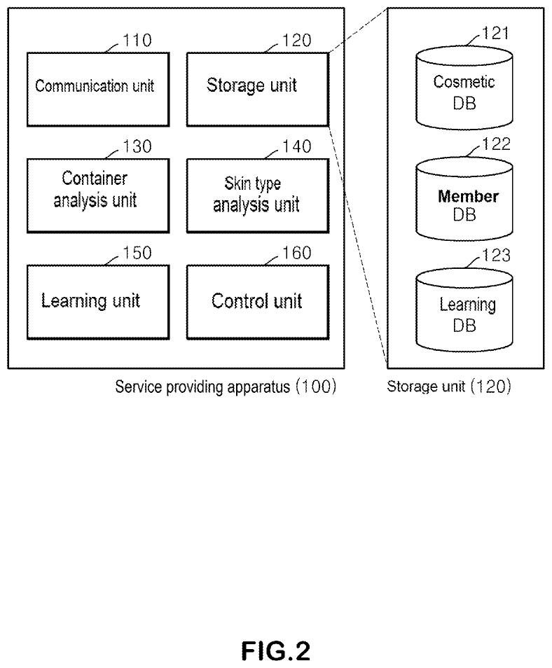

First, as illustrated in FIG. 2, the service providing apparatus 100 may include a communication unit 110 communicating with the user terminal via a communication network, a storage unit 120 for storing various information, a container analysis unit 130 for identifying cosmetics from a cosmetic container image (hereinafter, a container image) for a cosmetic container based on deep learning, a skin type analysis unit 140 for analyzing a skin type based on deep learning, and a control unit 160 for performing an overall control function of the service providing apparatus 100.

In this case, the storage unit 120 may be configured as a DB.

In addition, at least one component of the communication unit 110, the storage unit 120, the container analysis unit 130, the skin type analysis unit 140, and a learning unit 150 to be described below may also be configured to be included in the control unit 160.

In addition, the control unit 160 performs an overall control function of the service providing apparatus 100 using programs and data stored in the storage unit 120, and the control unit 160 may include a RAM, a ROM, a CPU, a GPU, and a bus, and the RAM, the ROM, the CPU, the GPU, etc. may be connected to each other via the bus.

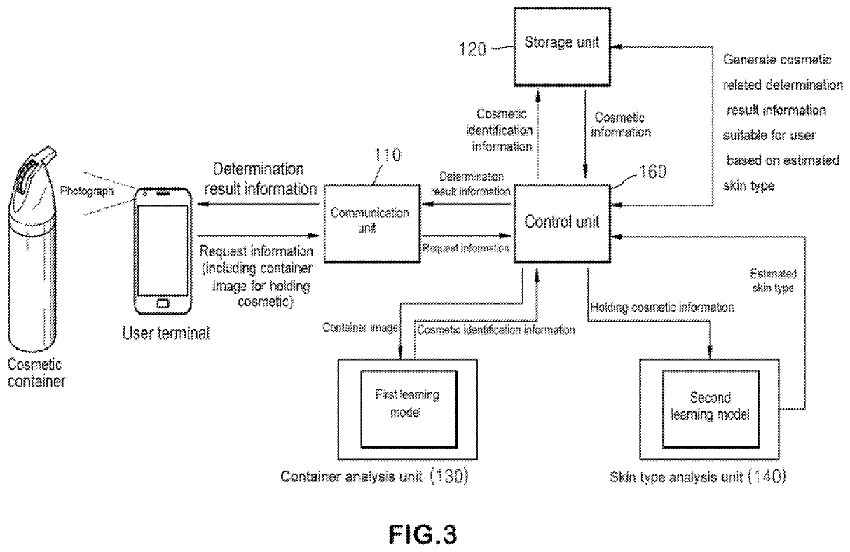

An example of an operation of the service providing apparatus 100 will be described with reference to FIG. 3 based on the above-described configuration.

First, the communication unit 110 may receive from the user terminal the request information including the cosmetic-specific container image generated by photographing the cosmetic container for each of one or more cosmetics used by the user.

In this case, the container image may include image data on a label of the cosmetic container, a shape of the cosmetic container, a size of the cosmetic container, a color of the cosmetic container, a bar code of the cosmetic container, and the like.

In addition, the request information may be information for asking for recommending or analyzing the cosmetics.

In addition, the storage unit 120 may include a cosmetic DB 121 in which cosmetic information on each of a plurality of different cosmetics and reference information on a cosmetic selection reference for each of a plurality of different skin types are stored.

In addition, the container analysis unit 130 may be configured to include a first learning model learned by matching the container image of the cosmetic with cosmetic identification information corresponding to the cosmetic.

In this case, in the first learning model, the container image and the cosmetic identification information are learned by matching each other for each of the plurality of different cosmetics, so that a correlation between the container image and the cosmetic identification information may be learned.

Accordingly, the container analysis unit 130 may apply the cosmetic-specific container image included in the request information to the first learning model, and calculate cosmetic identification information corresponding to the container image (having the highest correlation (correlation coefficient) with the container image) for each container image included in the request information through the first learning model.

Through this, the container analysis unit 130 may obtain one or more pieces of cosmetic identification information corresponding to one or more container images included in the request information through the first learning model.

In addition, the skin type analysis unit 140 may include a second learning model in which a correlation between ingredients constituting the cosmetics and the skin type is learned.

At this time, the plurality of skin types learned in the second learning model may be set and learned as various skin types such as dry, normal, oily, combination, and sensitive.

In addition, the first learning model and the second learning model may be constituted by a deep learning algorithm, and the deep learning algorithm may be constituted by one or more neural network models.

In addition, a neural network model (or neural network) described in the present disclosure may be consist of an input layer, one or more hidden layers, and an output layer, and the neural network model may applied with various types of neural networks, such as a deep neural network (DNN), a recurrent neural network (RNN), a convolutional neural network (CNN), a support vector machine (SVM), etc.

According to the above-described configuration, when receiving the request information by the communication unit 110, the control unit 160 may acquire one or more pieces of cosmetic identification information corresponding to the request information by the container analysis unit 130 (in conjunction with the container analysis unit 130).

In addition, the control unit 160 may search for the storage unit 120 based on one or more pieces of cosmetic identification information corresponding to the request information and obtained by the container analysis unit 130 to acquire one or more pieces of cosmetic information corresponding to the one or more pieces of cosmetic identification information as holding cosmetic information of each user.

In addition, the control unit 160 may extract one or more pieces of ingredient information from each of the one or more pieces of holding cosmetic information and then apply the extracted one or more pieces of ingredient information to the second learning model in conjunction with the skin type analysis unit 140 to calculate an estimated skin type predicted for the user, and determine the estimated skin type as the skin type of the user.

In addition, the control unit 160 may extract reference information on the cosmetic selection reference corresponding to the estimated skin type from the storage unit 120.

Further, the control unit 160 may generate determination result information of determining whether one or more holding cosmetics held by the user and the one or more pieces of holding cosmetic information corresponding thereto are suitable for the estimated skin type and include information on avoidable ingredients that need to be avoided, based on the reference information corresponding to the estimated skin type.

At this time, the determination result information may include information on one or more pieces of holding cosmetic information, and determination information of determining whether or not the one or more pieces of holding cosmetic information is suitable for the estimated skin type and includes the information on the avoidable ingredient that needs to be avoided.

In addition, the control unit 160 may transmit the determination result information to the user terminal through the communication unit 110.

According to the above-described configuration, the user terminal may display the determination result information received from the service providing device 100 to provide information on cosmetics containing ingredients that the user should avoid, and cosmetics that are not suitable for the user's skin type.

Meanwhile, the control unit 160 may set information on cosmetics which are suitable for the user and not contain ingredients to be avoided among the one or more pieces of holding cosmetic information as cosmetic information to be used or recommended cosmetic information based on the determination result information.

In addition, the control unit 160 may generate schedule information related to a usage schedule for the one or more pieces of cosmetic information based on at least one of the amount and usage included in each of the information on one or more cosmetics to be used and a using method in combination with cosmetics belonging to different categories to transmit the generated schedule information to the user terminal.

For example, when the control unit 160 determines each of a cleanser, an eye cream, and a moisturizer which are suitable for a user and do not contain ingredients to be avoided as cosmetics to be used based on the determination result information, the control unit 160 may determine an amount of use, the number of times of use, a use cycle, and an order of use of each of the cleanser, the eye cream, and the moisturizer for a week according to a capacity, a using method, and a using method in combination with cosmetics belong to different categories included in the corresponding cosmetic information for each cosmetic to be used. At this time, based on an amount of use, the number of times of use, a use cycle and an order of use of the cleanser, an amount of use, the number of times of use, a use cycle and an order of use of the eye cream may be determined at a preset ratio according to a using method in combination with the eye cream included in the cosmetic information of the cleanser to generate the schedule information.

Through this, the control unit 160 may not only automatically prepare and provide a schedule for efficiently using one or more cosmetics held by the user, but also provide a using method for each cosmetic to be used suitable for the skin care of the user.

Meanwhile, in the storage unit 120, information on one or more cosmetic tools matching at least one of a plurality of pieces of cosmetic information may be stored, and the cosmetic tool information may be stored in the cosmetic DB 121 of the storage unit 120.

Accordingly, the control unit 160 searches for the storage unit 120 based on the cosmetic information to be used and matches specific cosmetic tool information with cosmetic information matched with the specific cosmetic tool information in the schedule information to be included in the schedule information, when there is the specific cosmetic tool information matched with the cosmetic information to be used.

That is, the control unit 160 may recommend a cosmetic tool suitable for the use of the cosmetics to be used by the user to the user.

Through the above-described configuration, according to the present disclosure, it is possible to increase the convenience for the holding cosmetic input of the user by identifying the cosmetics held by the user only by photographing the containers of the cosmetics held by the user. In addition, it is possible to enhance user's convenience and satisfaction with skin care and reduce the time and cost required for selecting cosmetics suitable for the user's skin type by analyzing the cosmetics held by the user through artificial intelligence based on deep learning to estimate the user's skin type and then automatically selecting and providing cosmetics suitable for the user's skin type from among the cosmetics held by the user according to the estimated skin type.

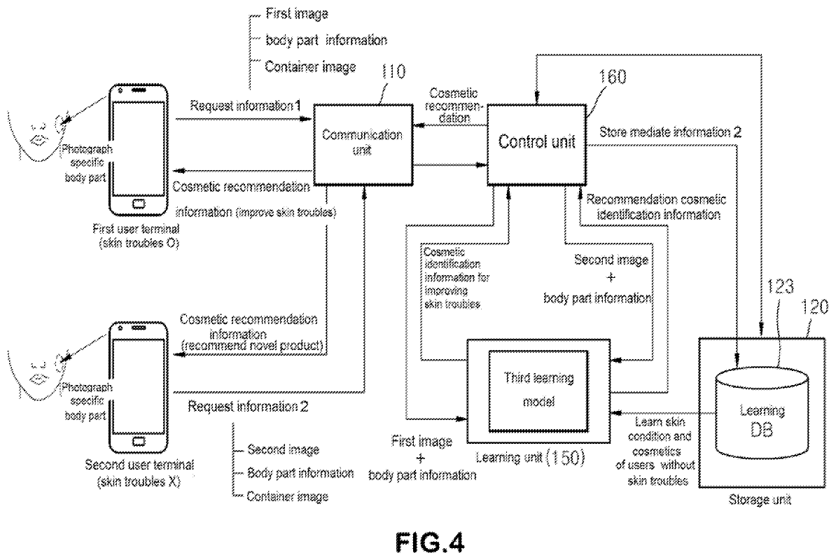

Meanwhile, according to the present disclosure, an abnormal user as a user who requests product recommendation to solve skin troubles when the skin troubles are generated in a specific body part is distinguished from a normal user as a user who requests recommendation to recommend popular or new products instead of solving the skin troubles when the skin troubles are not generated. Images related to a skin condition photographed for the specific body part of the normal user are matched and learned with holding cosmetics of the normal user to construct a learning model in which cosmetics with high preference among a large number of normal users are learned for various body parts and various skin types. While a popular product is recommended to the normal user for recommending the product through the corresponding learning model, for the abnormal user for solving the skin troubles, a list of cosmetics preferred by normal users who have a skin condition similar to the skin condition of the abnormal user and do not have skin troubles is calculated through the learning model. Thereafter, the list of cosmetics is recommended to the abnormal user to provide a product recommendation service capable of satisfying all of a plurality of different purposes of recommending cosmetics capable of solving the skin troubles of the abnormal user through a single learning model. It will be described in detail with reference to FIG. 4 based on the configuration described above.

For the above configuration, the communication unit 110 may receive the request information from the user terminal.

At this time, the request information may include skin condition information including whether skin troubles occur while including a first image that photographs the skin condition of a specific body part where skin troubles have occurred or a second image that photographs the skin condition of a specific body part where skin troubles does not occurred, and body part information on a container image for each cosmetic, which is generated by photographing the container for each of one or more cosmetics used on the specific body part through the camera unit of the user terminal, and a name for the specific body part.

In this case, as an example of the specific body part, any one of various body parts such as cheeks or forehead of the user's face, neck, arms, and legs may be included.

In addition, the skin troubles described in the present disclosure may include various abnormal symptoms, acne, boils, etc. occurring on the skin.

As an example of the generation of the request information, the control unit 160 may transmit user interface related data capable of inputting the request information for cosmetic recommendation to the user terminal through the communication unit 110.

Accordingly, the terminal control unit that is configured to the user terminal to perform the overall control function of the user terminal may display a user interface for generating the request information through a display unit configured in the user terminal based on the user interface related data received from the service providing apparatus 100 through the terminal communication unit configured in the user terminal.

Further, the terminal control unit may input, in the user interface, a specific image generated by photographing the specific body part of the user required for recommending the cosmetics through the camera unit configured in the user terminal and input, in the user interface, a container image for each cosmetic generated by photographing a cosmetic container through the camera unit for each of one or more holding cosmetics of the user being used on the specific body part.

Further, the terminal control unit may input, in the user interface, abnormality occurrence information on whether skin troubles have occurred in the specific body part based on the user input inputted in the user interface by the input unit configured in the user terminal. According to the abnormality occurrence information, the terminal control unit may set the specific image generated by photographing the specific body part when the skin troubles occur in the specific body part as the first image, and set the specific image when the skin troubles do not occur in the specific body part as the second image.

In addition, the terminal control unit may generate body part information about the name of the body part that referring to the specific body part based on the user input through the user interface.

Accordingly, the terminal control unit may generate skin condition information including the abnormality occurrence information while including the first image or the second image, cosmetic list information including the one or more cosmetic-specific container images, and the request information including the body part information and the like.

In this case, the terminal control unit may include user identification information or terminal identification information for identifying the user of the user terminal in the request information, and the user identification information may also be member identification information of the user.

Meanwhile, the service providing apparatus 100 may further include a learning unit 150 that matches one or more pieces of cosmetic identification information obtained to correspond to the request information by the container analysis unit 130 with the second image and the body part information included in the request information only for request information including the second image for the skin without the skin troubles to learn the matched information in a preset third learning model.

In this case, the control unit 160 or the learning unit 150 of the service providing apparatus 100 may identify the request information including the second image based on the abnormality occurrence information included in the request information to learn the identified request information in the third learning model of the learning unit 150.

In addition, the third learning model may also be configured as a deep learning algorithm like the first and second learning models, and the third learning model may be included in the learning unit 150.

Accordingly, a correlation between skin information including the second image and the body part information and cosmetic identification information may be learned in the third learning model.

In this case, the cosmetic identification information described in the present disclosure may include various information for cosmetic identification, such as a cosmetic unique number and a cosmetic name.

In addition, the control unit 160 may store the request information in the storage unit 120 when receiving the request information from the user terminal through the communication unit 110.

In this case, the storage unit 120 may further include a member DB 122 in which member information of the user is stored and a learning DB 123 in which the request information is stored.

Accordingly, the control unit 160 may store the request information in the learning DB 123 when receiving the request information. According to the control of the control unit 160, the learning unit 150 sets only request information of a normal user including abnormality occurrence information setting a skin condition in which skin troubles do not occur among the request information stored in the learning DB 123 as a learning target, and extracts the second image and the body part information from the request information that is the learning target to generate skin information. In addition, the learning unit 150 may acquire one or more pieces of cosmetic identification information corresponding to the request information that is the learning target in conjunction with the container analysis unit 130 and then generate learning data by matching the cosmetic identification information with the skin information and learn the learning data in the third learning model.

In the above configuration, the control unit 160 may match the request information with the member information of the user corresponding to the user terminal that has transmitted the request information from the member DB 122 to accumulatively store the matched request information.

Meanwhile, when the learning of the learning unit 150 (or the third learning model) is completed, the control unit 160 may apply any one of the first image and the second image and the body part information include in the request information to the third learning model in conjunction with the learning unit 150 when receiving the request information for requesting the cosmetic recommendation from the user terminal of the abnormal user or the normal user.

That is, the control unit 160 may apply any one of the first image and the second image and the body part information included in the request information to the third learning model as input information.

In addition, the control unit 160 may generate output information including cosmetic identification information for each of one or more cosmetics estimated to be used for a skin type similar to the user's skin type according to the any one of the first image and the second image and the body part information included in the request information so as to correspond to the input information.

That is, the third learning model may select learned images having the skin type for the skin of the specific body part similar to the skin type of the skin according to the first image with the skin troubles or the second image without the skin troubles which is photographed in relation to the skin of the specific body part inputted as the input information and output one or more pieces of cosmetic identification information having a high correlation with the learned images as the output information.

In this case, the control unit 160 may search for the storage unit 120 based on one or more pieces of cosmetic identification information included in the output information to extract one or more pieces of cosmetic information corresponding to the one or more pieces of cosmetic identification information included in the output information from the storage unit 120, respectively, and generate analysis result information including the one or more pieces of cosmetic information extracted from the storage unit 120 based on the output information.

In addition, the control unit 160 may confirm a correlation coefficient calculated through the third learning model for each of the one or more pieces of cosmetic identification information included in the output information to select only one or more pieces of cosmetic identification information in which the correlation coefficient is equal to or greater than a preset reference value, and also generate analysis result information including one or more pieces of cosmetic information corresponding to one or more pieces of cosmetic identification information selected based on the correlation coefficient from the output information.

In this case, when there is a plurality of pieces of cosmetic information belonging to the same category among the one or more pieces of cosmetic information included in the analysis result information, the control unit 160 may confirm a correlation coefficient for a plurality of pieces of cosmetic identification information corresponding to each of a plurality of pieces of cosmetic information belonging to the same category to include only cosmetic information having the highest correlation coefficient among the plurality of pieces of cosmetic information belonging to the same category included in the analysis result information in the analysis result information and delete (exclude) the remaining cosmetic information from the analysis result information.

As described above, when the control unit 160 applies to the third learning model the first image for the skin condition of the abnormal user with the skin troubles and the body part information on the specific body part having the corresponding skin condition which are included in the request information received from the user terminal of the abnormal user with the skin troubles, the control unit 160 may calculate analysis result information including cosmetic information for each of one or more cosmetics preferred by other users which is learned through the third learning model for the other users who are similar to the skin type of the abnormal user with skin troubles in the specific body part and have the skin condition without skin troubles in the specific body part.

In addition, when the control unit 160 applies to the third learning model the second image related to the skin condition of the specific body part of the normal user and the body part information on the corresponding specific body part which are included in the request information received from the user terminal of the normal user without the skin troubles, the control unit 160 may calculate analysis result information including cosmetic information for each of one or more cosmetics preferred by other users who are similar to the skin type of the normal user in the specific body part and have the skin condition without skin troubles.

In other words, the control unit 160 may calculate as analysis result information a list for cosmetics preferred by normal users who have a skin type similar to the skin type of the abnormal user, but have no skin troubles with respect to the abnormal user with skin troubles through the third learning model, but is preferred by normal users who do not have skin trouble. In addition, the control unit 160 may calculate as analysis result information a list for recommending cosmetics preferred by other normal users having a skin type similar to the skin type of the normal user to the normal user with respect to the normal user without skin troubles.

Meanwhile, when the analysis result information is calculated, the control unit 160 may generate cosmetic recommendation information based on the analysis result information and then transmit the generated cosmetic recommendation information to the user terminal through the communication unit 110. In this case, the control unit 160 may set each of one or more pieces of cosmetic information included in the analysis result information as recommendation cosmetic information to generate cosmetic recommendation information including the one or more pieces of recommendation cosmetic information.

At this time, the control unit 160 may transmit the determination result information as the cosmetic recommendation information to the user terminal through the communication unit 110.

In addition, the control unit 160 may generate holding list information on holding cosmetics of the user including one or more pieces of holding cosmetic information in conjugation with the container analysis unit 130 based on the request information and then compare the generated holding list information with the analysis result information. In addition, the control unit 160 may select one or more pieces of cosmetic information which are included in the holding list information but not included in the analysis result information as use suspension cosmetics, respectively. In addition, the control unit 160 may generate use suspension recommendation information including cosmetic information on each of one or more use suspension cosmetics and transmit the generated use suspension recommendation information to the user terminal or transmit the use suspension recommendation information included in the cosmetic recommendation information transmitted to the user terminal.

Meanwhile, the control unit 160 may receive cosmetic combination information for cosmetic identification information for each of one or more new cosmetics corresponding to the second image extracted from the request information including the second image from an external device through the communication unit 110 and learn the second image, the body part information, and the cosmetic combination information to the third learning model.

That is, the control unit 160 may transmit the second image for the skin condition of the normal user extracted from the request information to be learned to an external device of a manager who sells cosmetics. In addition, the control unit 160 may receive cosmetic combination information including cosmetic identification information for each of one or more new cosmetics which are new products suitable for being used for the skin condition according to the second image from the external device of the corresponding manager. In addition, the control unit 160 may match the corresponding cosmetic combination information with the second image and the body part information to learn the matched cosmetic combination information in the third learning model, so that the new cosmetics may be reflected in the third learning model.

Meanwhile, the service providing apparatus 100 may transmit cosmetic recommendation information to the user terminal to receive feedback information about the cosmetics used by the user in the cosmetic recommendation information from the user terminal. In addition, the service providing apparatus 100 may learn the feedback information in the third learning model together with the image included and transmitted in the request information when requesting the cosmetic recommendation of the user to continuously update cosmetics preferred by a plurality of users in the third learning model while cosmetics that are effective for the skin condition with skin troubles are learned in the third learning model.

First, the control unit 160 may receive the feedback information including cosmetic identification information for one or more using cosmetics used by the user among the recommendation cosmetics included in the recommendation information from the user terminal that has received the cosmetic recommendation information.

In this case, the feedback information may include user identification information (or terminal identification information), additional information for identification of request information corresponding to the feedback information, and the like.

In addition, the control unit 160 may confirm the request information corresponding to the feedback information in the member DB 122. In addition, the control unit 160 may extract the first image or the second image and the body part information from the request information corresponding to the feedback information and then match the extracted image and body part information with cosmetic identification information for each of one or more using cosmetics included in the feedback information. In addition, the control unit 160 may learn the learning data generated to correspond to the feedback information in the third learning model in conjugation with the learning unit 150.

At this time, the control unit 160 may confirm a recommendation score according to the feedback information to generate learning data based on the feedback information only when the recommendation score is equal to or greater than a preset reference value, and learn the generated learning data in the third learning model.

Through this, the control unit 160 also learns the first image of the user with skin troubles in the third learning model, but matches and learns the corresponding cosmetic identification information with the first image only when there are cosmetics that are effective for skin troubles with respect to the first image for the skin with skin troubles. When recommending cosmetics to other users who have skin troubles in the future, the control unit 160 may accurately determine abnormal users who are similar to the skin condition and the skin type of other users with skin troubles to recommend cosmetics recommended by the corresponding abnormal users to other users, thereby developing the third learning model so as to have the skin trouble solving function of other users.

Meanwhile, in the above configuration, the control unit 160 may match one or more pieces of holding cosmetic information corresponding to the request information with member information of the user corresponding to the user terminal to cumulatively store the matched information in the member DB 122 of the storage unit 120.

Accordingly, the control unit 160 generates preference information for the user based on the cumulatively stored holding cosmetic information, and reflects the preference information when generating the cosmetic recommendation information to select one or more recommendation cosmetics to be included in the cosmetic recommendation information.

In this case, the preference information may include at least one of a brand, a price range, and ingredients preferred by the user for each cosmetic category.

Further, according to the present disclosure, it is possible to support the skin troubles of an abnormal user by dividing users requesting a recommendation cosmetic for skin care into an abnormal user with skin troubles and a normal user without skin troubles to first learn a learning model with the image for the skin condition and holding cosmetics of the normal user and then recommending cosmetics to be preferred between normal users with a skin type similar to that of the abnormal user through the corresponding leaning model to induce the abnormal user to use the preference cosmetics of the normal users similar to the skin type of the abnormal user. Further, according to the present disclosure, it is possible to increase accuracy and reliability for the cosmetic recommendation capable of improving the skin troubles by receiving the feedback information form the abnormal user when the cosmetics to be recommended in the future has an effect of improving the skin troubles to learn the recommendation cosmetics used for improving skin troubles according to the image with the skin troubles first transmitted by the abnormal user and the feedback information in the learning model, so that the skin troubles occur, and more accurately selecting experienced persons who have experienced skin troubles similar to those of new users based on the learning model for new users who request cosmetic recommendation to recommend the cosmetics recommended by the corresponding experienced persons to new users.

Further, according to the present disclosure, the most preferred cosmetics are recommended between other normal users having the skin type similar to the abnormal user through the learning model with respect to the cosmetic recommendation request of the normal user without skin troubles to support the user without skin troubles to recommend the cosmetics in which opinions of the a plurality of users are reflected to improve the skin of the user, thereby providing a cosmetic recommendation function capable of satisfying both the user with skin troubles and the user without skin troubles.

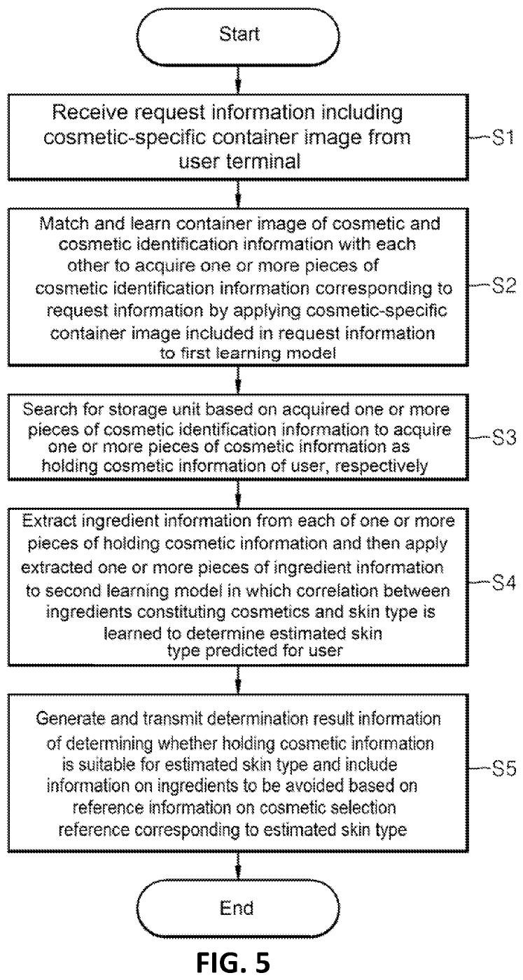

FIG. 5 is a flowchart of a service providing method for skin care based on image analysis of the service providing apparatus 100 according to an embodiment of the present disclosure.

First, the service providing apparatus 100 may receive from the user terminal request information including the cosmetic-specific container image in which the container for each of one or more using cosmetics is photographed (S1).

In addition, the service providing apparatus 100 may learn the correlation between the container image of the cosmetic and the cosmetic identification information corresponding to the cosmetic to acquire one or more pieces of cosmetic identification information corresponding to the request information by applying the cosmetic-specific container image corresponding to the request information (S2).

Further, the service providing apparatus 100 may search for the storage unit 120 of the service providing apparatus 100 in which the cosmetic information on each of a plurality of different cosmetics and reference information for the cosmetic selection reference for each of the plurality of different skin types are stored based on the one or more pieces of cosmetic identification information to acquire one or more pieces of cosmetic information corresponding to the one or more pieces of cosmetic identification information as the holding cosmetic information of the user, respectively (S3).

In addition, the service providing device 100 may extract ingredient information from each of the one or more pieces of holding cosmetic information and then apply the extracted one or more pieces of ingredient information to a second learning model in which a correlation between the ingredients constituting the cosmetic and the skin type is learned to determine an estimated skin type predicted for the user (S4).

In addition, the service providing device 100 may generate determination result information of determining whether the one or more pieces of holding cosmetic information is suitable for the estimated skin type and include information on ingredients to be avoided based on the reference information corresponding to the estimated skin type to provide the generated determination result information to the user terminal (S5).

For example, the components described in the embodiments of the present disclosure may be implemented using one or more general-purpose computers or special-purpose computers, such as hardware such as a storage unit such as a memory, a processor, a control unit, an arithmetic logic unit (ALU), a digital signal processor, a microcomputer, a field programmable gate array (FPA), a programmable logic unit (PLU), and a microprocessor, software including instruction sets, and combinations thereof, or other any devices capable of executing and responding instructions.

The aforementioned contents can be corrected and modified by those skilled in the art without departing from the essential characteristics of the present disclosure. Therefore, the exemplary embodiments disclosed in the present disclosure are intended not to limit the technical spirit of the present disclosure but to describe the present disclosure and the scope of the technical spirit of the present disclosure is not limited by these exemplary embodiments. The protective scope of the present disclosure should be construed based on the appended claims, and all the technical spirits in the equivalent scope thereof should be construed as falling within the scope of the present disclosure.

What is claimed is:

1. A service providing apparatus for skin care based on image analysis comprising:
a communication unit that receives from a user terminal request information including a cosmetic-specific container image obtained by photographing the container for each of one or more using cosmetics;
a storage unit in which cosmetic information on each of a plurality of different cosmetics and reference information on a cosmetic selection reference for each of a plurality of different skin types are stored;
a container analysis unit that learns a correlation between the container image of the cosmetic and the cosmetic identification information corresponding to the cosmetic to acquire one or more pieces of cosmetic identification information corresponding to the request information by applying the cosmetic-specific container image included in the request information to a preset first learning model;
a skin type analysis unit that includes a second learning model in which a correlation between ingredients constituting the cosmetics and the skin type is learned; and
a control unit that acquires one or more pieces of cosmetic identification information corresponding to the request information by the container analysis unit when receiving the request information by the communication unit, searches for the storage unit based on the acquired one or more pieces of cosmetic identification information to acquire one or more pieces of cosmetic information corresponding to the acquired one or more pieces of cosmetic identification information as holding cosmetic information of each user, extracts ingredient information from each of the one or more pieces of holding cosmetic information and then applies the extracted one ore more pieces of ingredient information to the second learning model in conjunction with the skin type analysis unit to determine an estimated skin type predicted for the user, and provides determination result information of determining whether one or more pieces of holding cosmetic information are suitable for the estimated skin type and include information on avoidable ingredients that need to be avoided, based on the reference information corresponding to the estimated skin type.

2. The service providing apparatus of claim 1, wherein the control unit sets cosmetic information which is suitable for a user and does not contain ingredients to be avoided among the one or more pieces of holding cosmetic information as cosmetics to be used based on the determination result information, and generates schedule information related to a usage schedule for the one or more pieces of cosmetic information to be used based on at least one of the amount and usage included in each of the information on one or more cosmetics to be used and a using method in combination with cosmetics belonging to different categories to transmit the generated schedule information to the user terminal.

3. The service providing apparatus of claim 1, wherein the storage unit stores information on one or more cosmetic tools matching at least one of a plurality of pieces of cosmetic information, and
the control unit searches for the storage unit based on the cosmetic information to be used and matches specific cosmetic tool information with cosmetic information matched with the specific cosmetic tool information in the schedule information to be included in the schedule information, when there is the specific cosmetic tool information matched with the cosmetic information to be used.

4. The service providing apparatus of claim 1, wherein
the request information includes skin condition information including whether skin troubles occur while including a first image that photographs the skin condition of a specific body part where skin troubles have occurred or a second image that photographs the skin condition of a specific body part where skin troubles does not occurred, and body part information on a container image for each cosmetic obtained by photographing the container for each of one or more cosmetics used on the specific body part, and a name for the specific body part,
further comprising: a learning unit that matches one or more pieces of cosmetic identification information obtained by the container analysis unit with the second image and the body part information only for request information including the second image for the skin without the skin troubles to learn the matched information in a preset third learning model,
wherein the control unit applies any one of the first image and the second image and the body part information included in the request information to the third learning model as input information in conjugation with the learning unit when receiving the request information to calculate output information including cosmetic identification information for each of one or more cosmetics estimated to be used for a skin type similar to the user's skin type through the third learning model, and searches for the storage unit based on one or more pieces of cosmetic identification information included in the output information to generate cosmetic recommendation information including one or more pieces of cosmetic information corresponding to the output information and then transmits the generated cosmetic recommendation information to the user terminal.

5. The service providing apparatus of claim 4, wherein the control unit receives cosmetic combination information for each of one or more new cosmetics corresponding to the second image extracted from the request information including the second image through the communication unit and matches the second image and the cosmetic combination information with the body part information extracted from the request information corresponding to the second image to learn the matched information in the third learning model.

6. The service providing apparatus of claim 4, wherein when the control unit receives the feedback information including cosmetic identification information for one or more using cosmetics used by the user among the recommendation cosmetics included in the cosmetic recommendation information from the user terminal that has received the cosmetic recommendation information, the control unit extracts the first image or the second image and the body part information from the request information corresponding to the feedback information and then matches the extracted image and body part information with cosmetic identification information for each of one or more using cosmetics included in the feedback information to learn learning data, and learns the learning data corresponding to the feedback information in the third learning model in conjugated with the learning unit.

7. The service providing apparatus of claim 6, wherein the control unit confirms a recommendation score according to the feedback information to generate the learning data based on the feedback information only when the recommendation score is equal to or greater than a preset reference value, and learns the generated learning data in the third learning model.

8. The service providing apparatus of claim 4, wherein the control unit matches one or more pieces of holding cosmetic information corresponding to the request information with member information of the user corresponding to the user terminal to cumulatively store the matched information in the storage unit, generates preference information for the user based on the cumulatively stored holding cosmetic information, and reflects the preference information when generating the cosmetic recommendation information to select one or more recommendation cosmetics to be included in the cosmetic recommendation information.

9. The service providing apparatus of claim 8, wherein the preference information includes at least one of a brand, a price range, and ingredients preferred by the user for each cosmetic category.

10. The service providing apparatus of claim 1, wherein the container image includes image data on at least one of a label of the cosmetic container, a shape of the cosmetic container, a size of the cosmetic container, a color of the cosmetic container, a bar code of the cosmetic container, and the like.

11. A service providing method for skin care based on image analysis comprising steps of:
receiving, by a service providing apparatus, from a user terminal request information including a cosmetic-specific container image obtained by photographing a container for each of one or more using cosmetics;
learning, by the service providing apparatus, a correlation between the container image of the cosmetic and cosmetic identification information corresponding to the cosmetic to acquire one or more pieces of cosmetic identification information corresponding to the request information by applying the cosmetic-specific container image included in the request information to a preset first learning model;
searching, by the service providing apparatus, for the storage unit of the service providing apparatus in which the cosmetic information on each of a plurality of different cosmetics and reference information for the cosmetic selection reference for each of the plurality of different skin types are stored based on the one or more pieces of cosmetic identification information to acquire one or more pieces of cosmetic information corresponding to the one or more pieces of cosmetic identification information as the holding cosmetic information of the user, respectively;
extracting, by the service providing apparatus, ingredient information from each of the one or more pieces of holding cosmetic information and then applying the extracted one or more pieces of ingredient information to a preset second learning model in which a correlation between the ingredients constituting the cosmetic and the skin type is learned to determine an estimated skin type predicted for the user; and
generating, by the service providing apparatus, determination result information of determining whether the one or more pieces of holding cosmetic information are suitable for the estimated skin type and include information on ingredients to be avoided based on the reference information corresponding to the estimated skin type to provide the generated determination result information to the user terminal.
